(19) United States
(12) Patent Application Publication
(10) Pub. No.: US 2025/0253656 A1
(43) Pub. Date: Aug. 7, 2025

(54) SYSTEM AND METHOD FOR REGULATING POWER USAGE BY A MEDICAL IMAGING SYSTEM BASED ON THE TIME OF DAY TO SAVE POWER COST

(71) Applicant: GE Precision Healthcare LLC, Waukesha, WI (US)

(72) Inventors: Goutam Maji, Bangalore (IN); Sooraj A, Kollam (IN); Dhaval Pravinbhai Dangashiya, Ahmedabad (IN)

(21) Appl. No.: 18/433,725

(22) Filed: Feb. 6, 2024

(51) Int. Cl. H02J 3/00; H02J 13/00

(52) U.S. Cl. CPC H02J 3/003; H02J 13/00004; H02J 2310/60

(57) ABSTRACT

A power distribution unit for a medical imaging system includes a battery system integrated within the medical imaging system, wherein the battery system is configured to receive electrical power from an electrical grid and to store the electrical power. The power distribution unit also includes a time of day tariff controller configured to communicate with a smart meter to determine both a non-peak period of a day and a peak period of the day for usage of the electrical power from the electrical grid and related tariff information. The time of day tariff controller is configured to regulate utilization of the electrical power from both the electrical grid and the battery system based on a time of the day and the related tariff information. This enables net zero electricity consumption and the reduction of overall electricity consumption cost.

### BACKGROUND

The subject matter disclosed herein relates to imaging systems and, more particularly, to a system and method for regulating power usage by a medical imaging system based on the time of day to save power cost.

Non-invasive imaging technologies allow images of the internal structures or features of a patient to be obtained without performing an invasive procedure on the patient. In particular, such non-invasive imaging technologies rely on various physical principles, such as the differential transmission of X-rays through the target volume or the reflection of acoustic waves, to acquire data and to construct images or otherwise represent the observed internal features of the patient.

For example, in computed tomography (CT) and other X-ray based imaging technologies, X-ray radiation spans a subject of interest, such as a human patient, and a portion of the radiation impacts a detector where the image data is collected. In digital X-ray systems a photodetector produces signals representative of the amount or intensity of radiation impacting discrete pixel regions of a detector surface. The signals may then be processed to generate an image that may be displayed for review. In CT imaging systems, a detector array, including a series of detector elements, produces similar signals through various positions as a gantry is displaced around a patient.

A typical CT imaging system draws utility power whenever there is a patient to be scanned. Thus, there is no control related to utilizing low cost electricity or to participate in a time of day tariff as the patient can come any time of the day. By not participating in a time of day tariff and utilizing low cost power, the electricity bill cannot be reduced for typical CT imaging system operation. In addition, due to massive integration of solar generated power on the electricity grid, during the day the cost of electricity is becoming less compared to the evening when the demand for is reaching a peak. Sometimes the cost of electricity can be very dynamic. Therefore there is a need to be smart enough to be aware of load needs and to regulate power usage to reduce electricity consumption costs.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In one embodiment, a power distribution unit for a medical imaging system is provided. The power distribution unit includes a battery system integrated within the medical imaging system, wherein the battery system is configured to receive electrical power from an electrical grid and to store the electrical power. The power distribution unit also includes a time of day tariff controller configured to communicate with a smart meter to determine both a non-peak period of a day and a peak period of the day for usage of the electrical power from the electrical grid and related tariff information. The time of day tariff controller is configured to regulate utilization of the electrical power from both the electrical grid and the battery system based on a time of the day and the related tariff information.

In another embodiment, a method for regulating use of electrical power by a medical imaging system is provided. The method includes communicating, via a time of day tariff controller of a power distribution unit for the medical imaging system, with a smart meter to determine both a non-peak period of a day and a peak period of the day for usage of the electrical power from an electrical grid and related tariff information. The method also includes regulating, via the time of data tariff controller, utilization of the electrical power from both the electrical grid and a battery system of the power distribution unit integrated within the medical imaging system based on a time of the day and the related tariff information.

In a further embodiment, a medical imaging system is provided. The medical imaging system includes a power distribution unit. The power distribution unit includes a battery system integrated within the medical imaging system, wherein the battery system is configured to receive electrical power from an electrical grid and to store the electrical power. The power distribution also includes a time of day tariff controller configured to communicate with a smart meter to determine both a non-peak period of a day and a peak period of the day for usage of the electrical power from the electrical grid and related tariff information. The time of day tariff controller is configured to regulate utilization of the electrical power from both the electrical grid and the battery system based on a time of the day and the related tariff information.

### BRIEF DESCRIPTION OF THE DRAWINGS

These and other features, aspects, and advantages of the disclosed subject matter will become better understood when the following detailed description is read with reference to the accompanying drawings in which like characters represent like parts throughout the drawings, wherein:

FIG. 1 is a combined pictorial view and block diagram of a computed tomography (CT) imaging system as discussed herein;

FIG. 2 is a block diagram for a medical imaging load, in accordance with aspects of the present disclosure;

FIG. 3 is a representative graph of energy demand for a typical working day;

FIG. 4 is a block diagram of a power distribution unit for a computed tomography imaging system, in accordance with aspects of the present disclosure;

FIG. 5 is flowchart of a method for regulating use of electrical power by a medical imaging system (e.g., for a computed tomography imaging system), in accordance with aspects of the present disclosure;

FIG. 6 is flowchart of a more detailed method for regulating use of electrical power by a medical imaging system (e.g., for a computed tomography imaging system), in accordance with aspects of the present disclosure;

FIG. 7 is a block diagram of a power distribution unit for a computed tomography imaging system (e.g., power distribution operation during non-peak hours and the computed tomography imaging system is running), in accordance with aspects of the present disclosure;

FIG. 8 is a block diagram of a power distribution unit for a computed tomography imaging system (e.g., power distribution operation during non-peak hours and the computed tomography imaging system is idle), in accordance with aspects of the present disclosure;

FIG. 9 is a block diagram of a power distribution unit for a computed tomography imaging system (e.g., power distribution operation during peak hours and the computed tomography imaging system is idle), in accordance with aspects of the present disclosure;

FIG. 10 is a block diagram of a power distribution unit for a computed tomography imaging system (e.g., power distribution operation during peak hours and the computed tomography imaging system is running), in accordance with aspects of the present disclosure; and

FIG. 11 is a block diagram of a power distribution unit for a computed tomography imaging system (e.g., power distribution operation during peak hours and the computed tomography imaging system is running when battery has extra charge available), in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While aspects of the following discussion are provided in the context of medical imaging, it should be appreciated that the disclosed techniques are not limited to such medical contexts. Indeed, the provision of examples and explanations in such a medical context is only to facilitate explanation by providing instances of real-world implementations and applications. However, the disclosed techniques may also be utilized in other contexts, such as image reconstruction for non-destructive inspection of manufactured parts or goods (i.e., quality control or quality review applications), and/or the non-invasive inspection of packages, boxes, luggage, and so forth (i.e., security or screening applications). In general, the disclosed techniques may be useful in any imaging or screening context or image processing or photography field where a set or type of acquired data undergoes a reconstruction process to generate an image or volume.

The present disclosure provides embodiments for a system and a method for regulating power usage by a medical imaging system based on the time of day to save energy consumption cost. The medical imaging system may be a computed tomography imaging system, an X-ray imaging system, a positron emission tomography imaging system, a single-photon emission tomography imaging system, a magnetic resonance imaging system, or other type of medical imaging system. In particular, a battery-based solution is utilized in the medical imaging system to reduce overall electricity consumption cost. The medical imaging system includes an integrated battery that can be charged with higher power during non-peak hours of the day (e.g., consuming low cost electricity) and use grid power to the medical imaging system as much as possible. During peak hours of the day, the medical imaging system can use the stored energy (e.g., stored in the battery) and deliver surplus storage energy to the electrical grid (e.g., selling high cost electricity) if there is any surplus stored energy available in the battery. This way the medical imaging system can run with battery power during the peak time of the day (ToD) tariff and the same battery can charge with high power when the time of day tariff is low/lowest to achieve net zero/near zero energy cost over a period of time.

In certain embodiments, a power distribution unit for a medical imaging system is provided. The power distribution unit includes a battery system integrated within the medical imaging system, wherein the battery system is configured to receive electrical power from an electrical grid and to store the electrical power. The power distribution unit also includes a time of day tariff controller configured to communicate with a smart meter to determine both a non-peak period of a day and a peak period of the day for usage of the electrical power from the electrical grid and related tariff information (e.g., static tariff information and/or dynamic tariff information such as tariff for period or time of day). The time of day tariff controller is configured to regulate utilization of the electrical power from both the electrical grid and the battery system based on a time of the day and the related tariff information.

In certain embodiments, the time of day tariff controller is configured when the medical imaging system is being utilized during the non-peak period both to cause utilization of the electrical power directly from the electrical grid to power one or more components of the medical imaging system and to cause charging of the battery system. In certain embodiments, the time of day tariff controller is configured when the medical imaging system is being utilized during the non-peak period to cause utilization of the electrical power stored in the battery system to power the one or more components of the medical imaging system to provide peak power shaving during peak power operation of the medical imaging system.

In certain embodiments, the time of day tariff controller is configured when the medical imaging system is not being utilized during the non-peak period to cause charging of the battery system. In certain embodiments, the related tariff information includes dynamic tariff information. The time of day tariff controller is configured when the medical imaging system is not being utilized during the non-peak period to cause variable charging of the battery system where the battery system is charged at maximum power when a tariff is lowest during the non-peak period and the battery system is charged at less than maximum power when the tariff rises during the non-peak period.

In certain embodiments, the time of day tariff controller is configured when the medical imaging system is not being utilized during the peak period both to cause stopping of charging of the battery system and to cause the electrical power stored in the battery system to be fed back to the electrical grid. In certain embodiments, the time of day tariff controller is configured when the medical imaging system is being utilized during the peak period both to cause stopping of charging of the battery system and to cause utilization of the electrical power stored in the battery system to power one or more components of the medical imaging system. In certain embodiments, the time of day tariff controller is configured when the medical imaging system is being utilized during the peak period both to cause utilization of the electrical power stored in the battery system to power one or more components of the medical imaging system and to cause charging of the battery system.

In certain embodiments, a method to regulate use of electrical power by a medical imaging system is provided. The method includes communicating, via a time of day tariff controller of a power distribution unit for the medical imaging system, with a smart meter to determine both a non-peak period of a day and a peak period of the day for usage of the electrical power from an electrical grid and related tariff information. The method also includes regulating, via the time of data tariff controller, utilization of the electrical power from both the electrical grid and a battery system of the power distribution unit integrated within the medical imaging system based on a time of the day and the related tariff information.

In certain embodiments, the method includes, when the medical imaging system is being utilized during the non-peak period, causing, via the time of day tariff controller, utilization of the electrical power directly from the electrical grid to power one or more components of the medical imaging system and causing, via the time of day tariff controller, charging of the battery system. In certain embodiments, the method includes, when the medical imaging system is being utilized during the non-peak period, causing, via the time of day tariff controller, utilization of the electrical power stored in the battery system to power the one or more components of the medical imaging system to provide peak power shaving during peak power operation of the medical imaging system.

In certain embodiments, the method includes, when the medical imaging system is not being utilized during the non-peak period, causing, via the time of day tariff controller, charging of the battery system. In certain embodiments, the related tariff information includes dynamic tariff information. In certain embodiments, the method includes, when the medical imaging system is not being utilized during the non-peak period, causing, via the time of day tariff controller, variable charging of the battery system where the battery system is charged at maximum power when a tariff is lowest during the non-peak period and the battery system is charged at less than maximum power when the tariff rises during the non-peak period.

In certain embodiments, the method includes, when the medical imaging system is not being utilized during the peak period, causing, via the time of day tariff controller, stopping of charging of the battery system and causing, via the time of day tariff controller, the electrical power stored in the battery system to be fed back to the electrical grid. In certain embodiments, the method includes, when the medical imaging system is being utilized during the peak period, causing, via the time of day tariff controller, stopping of charging of the battery system and causing, via the time of day tariff controller, utilization of the electrical power stored in the battery system to power one or more components of the medical imaging system. In certain embodiments, the method includes, when the medical imaging system is being utilized during the peak period, causing, via the time of day tariff controller, utilization of the electrical power stored in the battery system to power one or more components of the medical imaging system and to cause charging of the battery system.

The disclosed embodiments provide a smart medical imaging system that reduces running electricity cost by participating in the time of day power tariff. The disclosed embodiments also provide for modulating battery charging and discharging based on the dynamic time of day tariff. The disclosed embodiments further reduces cost as the power distribution unit provides peak power shaving features. The disclosed embodiments even further enable one or more components of the medical imaging system to run on battery power (which is of better quality than utility power) which improves the reliability of parts or components. The disclosed embodiments still further enable remote health monitoring of the medical imaging system by communicating with a smart meter or the time of day tariff.

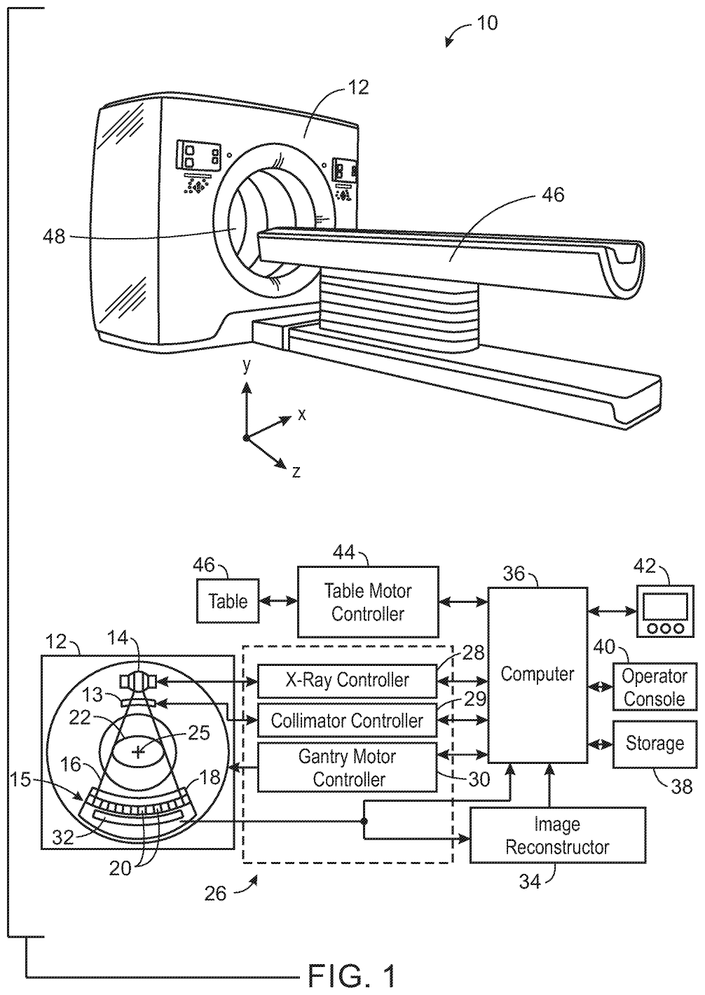

With the preceding in mind and referring to FIG. 1, a computed tomography (CT) imaging system 10 is shown, by way of example. The CT imaging system 10 includes a gantry 12. The gantry 12 has an X-ray source 14 that projects a beam of X-rays 16 toward a detector assembly 15 on the opposite side of the gantry 12. The X-ray source 14 projects the beam of X-rays 16 through a pre-patient collimator assembly 13 that determines the size and shape of the beam of X-rays 16. The detector assembly 15 includes a collimator assembly 18 (a post-patient collimator assembly), a plurality of detector modules 20 (e.g., detector elements or sensors), and data acquisition systems (DAS) 32. The plurality of detector modules 20 detect the projected X-rays that pass through a subject or object 22 being imaged, and DAS 32 converts the data into digital signals for subsequent processing. Each detector module 20 in a conventional system produces an analog electrical signal that represents the intensity of an incident X-ray beam and hence the attenuated beam as it passes through the subject or object 22. During a scan to acquire X-ray projection data, gantry 12 and the components mounted thereon rotate about a center of rotation 25 (e.g., isocenter) so as to collect attenuation data from a plurality of view angles relative to the imaged volume.

Rotation of gantry 12 and the operation of X-ray source 14 are governed by a control system 26 of CT imaging system 10. Control system 26 includes an X-ray controller 28 that provides power and timing signals to an X-ray source 14, a collimator controller 29 that controls a length and a width of an aperture of the pre-patient collimator 13 (and, thus, the size and shape of the beam of X-rays 16), and a gantry motor controller 30 that controls the rotational speed and position of gantry 12. An image reconstructor 34 receives sampled and digitized X-ray data from DAS 32 and performs high-speed image reconstruction. The reconstructed image is applied as an input to a computer 36, which stores the image in a storage device 38. Computer 36 also receives commands and scanning parameters from an operator via console 40. An associated display 42 allows the operator to observe the reconstructed image and other data from computer 36. The operator supplied commands and parameters are used by computer 36 to provide control signals and information to DAS 32, X-ray controller 28, collimator controller 29, and gantry motor controller 30. In addition, computer 36 operates a table motor controller 44, which controls a motorized table 46 (e.g., patient table) to position subject 22 and gantry 12. Particularly, table 46 moves portions of subject 22 through a gantry opening or bore 48.

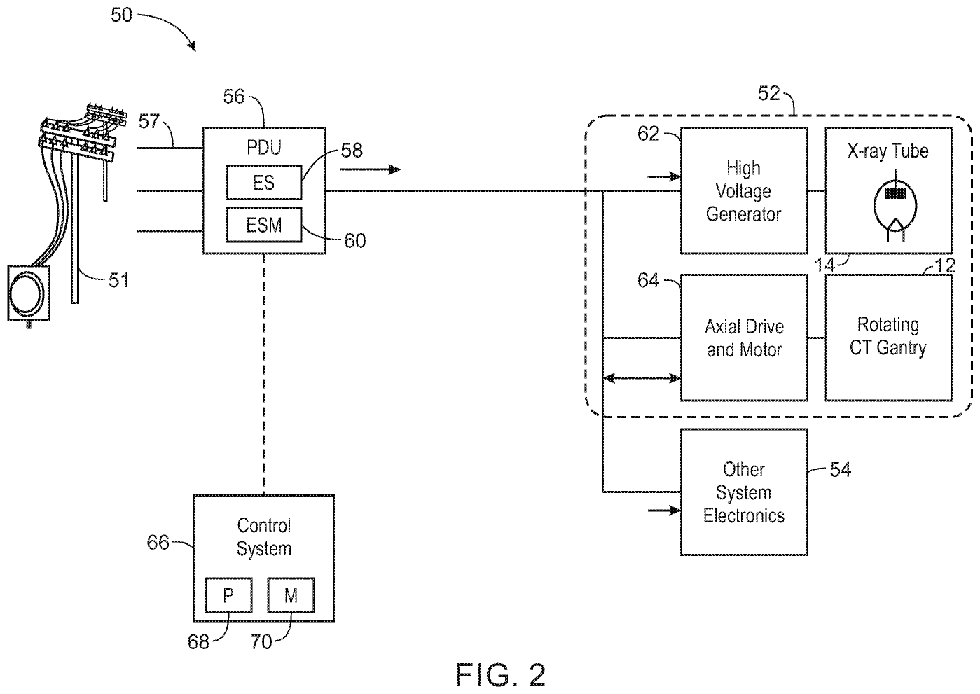

FIGS. 2 and 4-11 are discussed in the context of a computed tomography imaging system. As noted above, the disclosed embodiments can be utilized with other medical imaging systems (e.g., an X-ray imaging system, a positron emission tomography imaging system, a single-photon emission tomography imaging system, a magnetic resonance imaging system, or other type of medical imaging system). FIG. 2 is a power supply system 50 that provides power to one or more medical imaging loads 52 (e.g., computed tomography imaging system 10 of FIG. 1) and/or other electronics 54 (e.g., computer 36, console 40, and/or display 42 for computed tomography imaging system 10). A main alternating current (AC) power source (e.g., from an electrical grid) may provide power (e.g., single phase or polyphase AC power such as 3-phase AC power) via an AC power line 51 to a power distribution unit (PDU) 56 via an AC input 57 (e.g., single phase or 3-phase power plug). The power distribution unit 56 may convert the AC power to DC power and provide the DC power to the medical imaging loads 52 and/or other electronics 54. In certain embodiments, the power distribution unit 56 also provides AC power to the medical imaging loads 52 and/or other electronics 54. The power distribution unit 56 is disposed in a stationary portion of the CT imaging scanner of the system 10. The power distribution unit 56 may transmit power from the stationary portion to the rotating portion of the CT imaging scanner of the system 10 via a slip ring or wirelessly. In certain embodiments, the system 10 may utilize intelligent monitoring reporting of different parameters of the power supply system 50 (e.g., power distribution unit 56). These parameters may include input voltage, input current, battery voltage charge current, inverter AC voltage, inverter AC current, heat sink temperature, all board rail voltages, and other parameters. These parameters may be communicated (e.g., wired or wirelessly) to the host computer 36 and/or console 40 from the power distribution unit 56 via a communication interface (e.g., serial, controller area network, Ethernet, etc.).

The power distribution unit 56 includes an energy storage system 58 configured to store electrical power provided by the AC power line 51. In certain embodiments, the energy storage system 58 includes one or more energy storage components. For example, in certain embodiments, the energy storage system 58 may include a battery system having one or more battery banks. In certain embodiments, the energy storage components may include a plurality of batteries stacked in series.

The power distribution unit 56 also includes an energy storage management system 60 configured to manage or control the storage on and distribution of power from the energy storage system 58. In certain embodiments, the energy storage management system 60 may include a battery charger and control circuitry. In certain embodiments, the energy storage management system 60 is configured to enable storage of the electrical power on the energy storage system 58 (e.g., batteries) without pre-regulation of the electrical power. In certain embodiments, the energy storage management system 60 is configured to perform peak shaving utilizing the energy storage system 58 (e.g., during an imaging scan) by turning off power provided to the battery charger during acceleration of the gantry 12 and subsequently turning on power to the battery charger during emissions of X-rays from the X-ray source 14 (e.g., X-ray tube). In certain embodiments, the energy storage management system 60 is configured to monitor a life of the batteries of the energy storage system 58 and to provide an indication that the batteries are nearing an end of the life via a user interface. For example, the energy storage management system 60 may monitor the equivalent series resistance (ESR) of the batteries and compared it to a threshold (e.g., maximum allowable ESR value). In certain embodiments, the energy storage management system 60 may determine a charge status of the batteries and/or determine whether an imaging scan can be conducted. For example, the energy storage management system 60 may utilize the batteries for the peak power operation when there is enough charge in the batteries or, if there is not enough charge, wait to utilize the batteries for peak power operation when there is enough charge.

While one or more medical imaging loads 52 are described below with respect to loads for a computed tomography (CT) system, it will be appreciated that embodiments are applicable for use with other imaging configurations. The one or more medical imaging loads 52 may include a high voltage generator 62 coupled to the power distribution unit 56. The high voltage generator 62 may provide power to an X-ray tube 14, of the computed tomography (CT) imaging system 10. The X-ray tube 14 may emit X-ray beams toward a subject or object, such as a patient. The beam, after being attenuated by the subject, impinges upon an array of radiation detector. The intensity of the attenuated beam radiation received at the detector array may be dependent upon the attenuation of the X-ray beam by the subject. Each detector element of the detector array produces a separate electrical signal indicative of the attenuated beam received by each detector element. The electrical signals are transmitted to a data processing system for analysis which produces an image. Further, the X-ray source and the detector array may be rotated, via an axial drive and motor 64, about the gantry 12 within an imaging plane and around the subject or object. When the gantry 12 is rotated, it converts the power from the power distribution unit 56 to rotational kinetic energy via the motor 64.

The power distribution unit 56 may be controlled by a control system 66 having a FPGA or processor 68 or multiple FPGA or multiple processors and memory 70. In certain embodiments, the control system 66 is part of the power distribution unit 56 (e.g., energy storage management system 60). The processor 68 may be operatively coupled to the memory 70 to execute instructions for carrying out the presently disclosed techniques. These instructions may be encoded in programs or code stored in a tangible non-transitory computer-readable medium, such as the memory 70 and/or other storage. The processor 68 may be a general purpose processor (e.g., processor of a desktop/laptop computer), system-on-chip (SoC) device, or application-specific integrated circuit, or some other processor configuration. The memory 70, in the embodiment, includes a computer readable medium, such as, without limitation, a hard disk drive, a solid state drive, diskette, flash drive, a compact disc, a digital video disc, random access memory (RAM), and/or any suitable storage device that enables the processor 68 to store, retrieve, and/or execute instructions and/or data. The memory 70 may include one or more local and/or remote storage devices. The processor 68 may control components of the power distribution unit 56 (e.g., charger, batteries, etc.) to provide power to the one or more medical imaging loads 52.

As described in greater detail below, the control system 66 includes a time of day tariff controller and a power distribution unit controller (each of which has a processing system (e.g., one or more processors) and memory). The time of day tariff controller is configured to execute the instructions to communicate with a smart meter to determine both a non-peak period of a day and a peak period of the day for usage of the electrical power from the electrical grid and related tariff information (e.g., static tariff information and/or dynamic tariff information). The time of day tariff controller is configured to execute the instructions to regulate utilization of the electrical power from both the electrical grid and the battery system based on a time of the day and the related tariff information.

In certain embodiments, the time of day tariff controller is configured, when the medical imaging system is being utilized during the non-peak period, to execute the instructions both to cause utilization of the electrical power directly from the electrical grid to power one or more components of the medical imaging system and to cause charging of the battery system. In certain embodiments, the time of day tariff controller is configured, when the medical imaging system is being utilized during the non-peak period, to execute the instructions to cause utilization of the electrical power stored in the battery system to power the one or more components of the medical imaging system to provide peak power shaving during peak power operation of the medical imaging system.

In certain embodiments, the time of day tariff controller is configured, when the medical imaging system is not being utilized during the non-peak period, to execute the instructions to cause charging of the battery system. In certain embodiments, the related tariff information includes dynamic tariff information. The time of day tariff controller is configured, when the medical imaging system is not being utilized during the non-peak period, to execute the instructions to cause variable charging of the battery system where the battery system is charged at maximum power when a tariff is lowest during the non-peak period and the battery system is charged at less than maximum power when the tariff rises during the non-peak period.

In certain embodiments, the time of day tariff controller is configured, when the medical imaging system is not being utilized during the peak period, to execute the instructions both to cause stopping of charging of the battery system and to cause the electrical power stored in the battery system to be fed back to the electrical grid. In certain embodiments, the time of day tariff controller is configured, when the medical imaging system is being utilized during the peak period, to execute the instructions both to cause stopping of charging of the battery system and to cause utilization of the electrical power stored in the battery system to power one or more components of the medical imaging system. In certain embodiments, the time of day tariff controller is configured, when the medical imaging system is being utilized during the peak period, to execute the instructions both to cause utilization of the electrical power stored in the battery system to power one or more components of the medical imaging system and to cause charging of the battery system.

Differential time-based electricity tariffs or time of day tariff is a new normal configured to improve grid stability, to reduce demand during peak hours, and to reduce installed capacity to serve a connected load (i.e., to improve the load factor). The time of the day tariff includes discounted prices for power during daytime and premium or surge for power during peak power consumption hours. The time-based power tariff structures can be static (e.g., predetermined tariffs based on time blocks). The time-based power tariff structures can also be dynamic (e.g., determined on a real-time based in accordance with the actual demand conditions). There are other variants of the time-based power tariff structures are a combination of static and dynamic pricing models.

For example, under a static time of day tariff system, the power tariff during solar hours (e.g., during daytime), which may be a duration of eight hours a day or other time period (which is pre-specified by a respective electricity regulatory body) may be 20 percent lower than a normal tariff. On the other hand, tariffs during peak hours will be 20 percent or more higher than the normal tariff for commercial and industrial consumers, and at least 10 percent higher for other consumers.

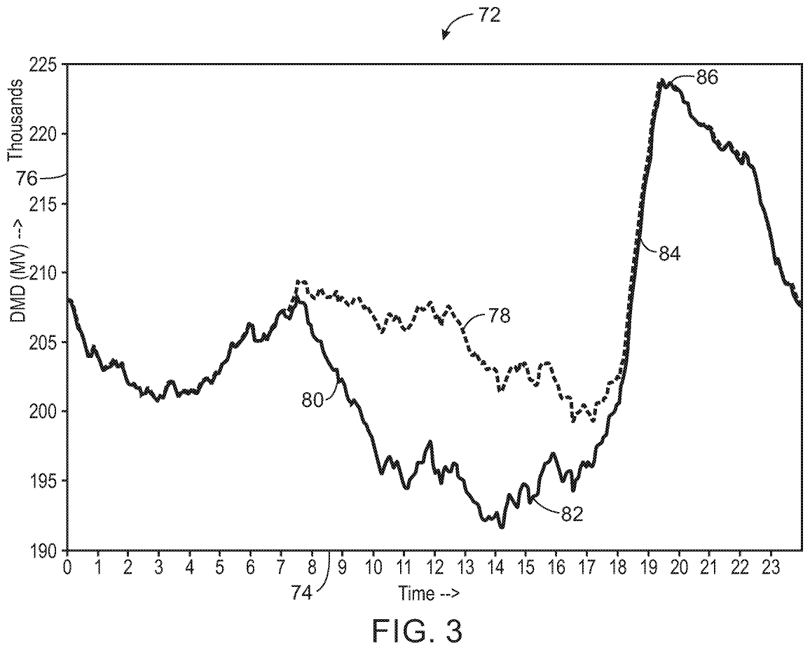

FIG. 3 is a representative graph 72 of energy demand for a typical working day (e.g., for an area such as a city or metropolitan area). The energy demand for a typical working day may vary based on the area, the time of year, daily conditions, and other factors. The graph 72 includes an x-axis 74 representing a time of a day and a y-axis 76 representing energy demand (e.g., in megawatts (MW)). Plot 78 represents actual electricity demand and plot 80 represents net load. During the period of 7 AM and 6 PM (i.e., during solar hours when solar power is generated), generated solar power reduces the net load as indicated by region 82 (e.g., belly) of the plot 80. Beginning at 6 PM, both the net load and the actual demand begin steeply increasing as indicated by region 84 (e.g., neck) of the plot 80. During 7 PM to 8 PM (during the evening), when solar power generation is not available, the net load is peaking (as indicated by region 86 (e.g., head) of the plot 80) due to domestic, commercial, and industrial load. Utilization of the embodiments described herein enables the medical imaging systems to reduce demand during the peak energy demand period.

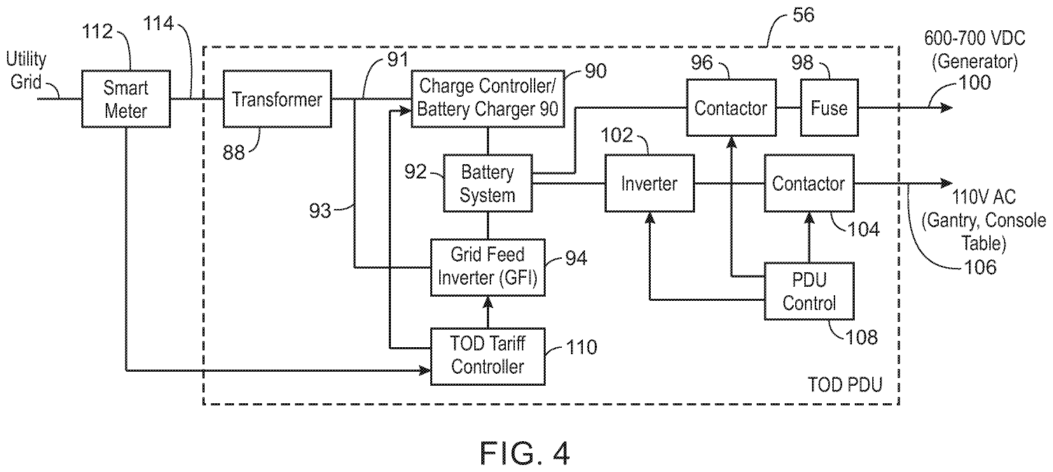

FIG. 4 is a block diagram of the power distribution unit 56 (e.g., battery-based time of day power distribution unit) for a computed tomography imaging system (e.g., computed tomography imaging system 10 in FIG. 1). The power distribution unit 56 is configured for time of day tariff participation and power peak shaving. The power distribution unit 56 is also configured to utilize grid power according to the time of day power tariff and to reduce overall cost of electricity usage.

The power distribution unit 56 includes a transformer 88 configured to receive power (e.g., alternating current (AC)) from an electrical grid (e.g., utility grid). The power distribution unit 56 also includes a charge controller/battery charger 90. The transformer 88 provides electrical power to the charge controller/battery charger 90 along line 91. The power distribution unit 56 also includes a battery system 92. The battery system 92 includes one or more battery banks configured to store electrical power. The charge controller/battery charger 90 is configured (when on or activated) to regulate the charging of the battery system 92 and the utilization of power stored in the battery system 92.

The power distribution unit 56 also includes a grid feed (GF) inverter 94 configured to receive stored power (e.g., direct current (DC)) from the battery system 92 and to convert the DC power to AC power. The grid feed inverter 94 is then configured (when on or activated) to provide the AC power back (e.g. for selling back) to the electrical grid (e.g., via line 93 to line 91) via the transformer 88.

The power distribution unit 56 further includes a DC contactor 96 and a fuse 98. The DC contactor 96 is disposed between the battery system 92 and the fuse 98. The DC contactor 96 and the fuse 98 are disposed along line 100 that provides DC power from the battery system 92 to the generator (e.g., high voltage generator 62 in FIG. 2) of the computed tomography system. The DC contactor 96 and the fuse 98 are high voltage DC enabled when high voltage DC power (e.g., 600 to 700 VDC) is provided from the battery system 92 along the line 100 to the generator.

The power distribution unit 56 also includes an inverter 102 and an AC contactor 104. The inverter 102 is disposed between the battery system 92 and the AC contactor 104. The inverter 102 is configured to convert DC power from the battery system 92 to AC power. The inverter 102 and the AC contactor are disposed along line 106 that provides AC power to components (e.g., gantry, console, table, etc.) of the computed imaging system. The inverter 102 and the AC contactor 104 are enabled when AC power (e.g., 110V AC) is provided to the components of the computed tomography imaging system along the line 106. The power distribution unit controller or control board 108 is communicatively coupled to the DC contactor 96, the inverter 102, and the contactor 104. The power distribution unit controller 108 is configured to provide control signals to activate (e.g. enable) and/or deactivate (e.g., disable) the DC contactor 96, the inverter 102, and the contactor 104 to regulate the power (AC power and DC power) provided to the various components of the computed tomography imaging system via the lines 100 and 106.

The power distribution unit 56 also includes a time of day (TOD) tariff controller 110. The power distribution unit 56 is configured to communicate with a smart meter 112 that is disposed along a line 114 providing electrical power (e.g., AC power) to the transformer 88. The smart meter 112 is configured to record real time energy consumption, peak power consumption for demand charge, voltage fluctuation, and other items (all with a time stamp). The smart meter 112 is also configured to communicate with the electricity body for static tariff information and dynamic information to provide this tariff information to the time of day tariff controller 110. The time of day tariff controller 110 is configured to communicate with the smart meter 112 to determine both a non-peak period of a day and a peak period of the day for usage of the electrical power from the electrical grid and related tariff information (e.g., static tariff information and/or dynamic tariff information).

The time of day tariff controller 110 is configured to provide control signals to the charge controller/battery charger 90 to regulate operation of the charge controller/battery charger 90 (e.g., activate charging, stop charging, alter charging rate, etc.) based on the. The time of day tariff controller 110 is also configured to provide control signals to the grid feed inverter 94 to activate or to deactivate the grid feed inverter 94. In particular, in certain scenarios, the grid feed inverter 94 may activated to receive stored power (e.g., DC power) from the battery system 92 and to convert the DC power to AC power. The grid feed inverter 94 is then configured (to provide the AC power back (e.g. for selling back) to the electrical grid (e.g., via line 93 to line 91) via the transformer 88. The time of day tariff controller 110 is also configured to communicate with and to provide control signals to the power distribution unit controller 108 for regulating the distribution of electrical power from the battery system 92 to the components of the computed tomography imaging system.

The time of day tariff controller 110 is configured (e.g., via control signals) to regulate utilization of the electrical power from both the electrical grid and the battery system 92 based on a time of the day and the related tariff information (e.g., static tariff information and/or dynamic tariff information). In certain embodiments, the time of day tariff controller 110 is configured, when the computed tomography imaging system is being utilized during the non-peak period, both to cause utilization of the electrical power directly from the electrical grid to power one or more components of the computed tomography imaging system and to cause charging of the battery system. In certain embodiments, the time of day tariff controller 110 is configured, when the computed tomography imaging system is being utilized during the non-peak period, to cause utilization of the electrical power stored in the battery system 92 to power the one or more components of the computed tomography imaging system to provide peak power shaving during peak power operation of the computed tomography imaging system.

In certain embodiments, the time of day tariff controller 110 is configured, when the computed tomography imaging system is not being utilized during the non-peak period, to cause charging of the battery system 92. In certain embodiments, the related tariff information includes dynamic tariff information. The time of day tariff controller 110 is configured, when the computed tomography imaging system is not being utilized during the non-peak period, to cause variable charging of the battery system 92 (via control signals to the charge controller/battery charger 90) where the battery system 92 is charged at maximum power when a tariff is lowest during the non-peak period and the battery system 92 is charged at less than maximum power when the tariff rises during the non-peak period.

In certain embodiments, the time of day tariff controller 110 is configured, when the computed tomography imaging system is not being utilized during the peak period, both to cause stopping of charging of the battery system 92 (via control signals to the charge controller/battery charger 90) and to cause the electrical power stored in the battery system 92 to be fed back to the electrical grid (via control signals provided to the grid feed inverter 94). In certain embodiments, the time of day tariff controller 110 is configured, when the computed tomography imaging system is being utilized during the peak period, both to cause stopping of charging of the battery system 92 (via control signals to the charge controller/battery charger 90) and to cause utilization of the electrical power stored in the battery system 92 to power one or more components of the computed tomography imaging system. In certain embodiments, the time of day tariff controller 110 is configured, when the computed tomography imaging system is being utilized during the peak period, both to cause utilization of the electrical power stored in the battery system 92 (via control signals to the charge controller/battery charger 90 and to the power distribution unit controller 108) to power one or more components of the computed tomography imaging system and to cause charging of the battery system 92.

As mentioned above, other medical imaging systems may utilize a similar power distribution unit. With these other medical imaging systems, the components that the power is distributed to may vary. In addition, with these other medical imaging systems, components downstream of the battery system 92 may vary.

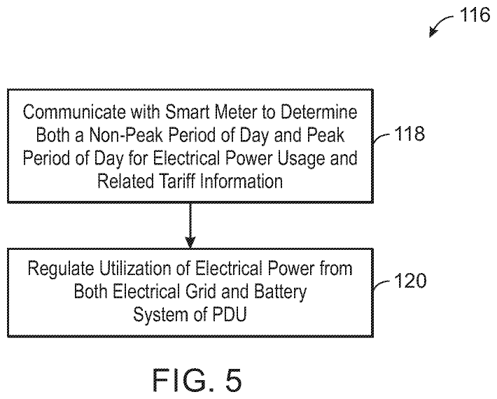

FIG. 5 is flowchart of a method 116 for regulating use of electrical power by a medical imaging system (e.g., for a computed tomography imaging system or other type of medical imaging system). One or more steps of the method 116 may be performed simultaneously and/or in a different order from that depicted in FIG. 5. The method 116 may be performed by one or more components of the power distribution unit 56 in FIG. 4 (e.g., time of day tariff controller 110, power distribution unit controller 108, charge controller/battery charger 90, etc.).

The method 116 includes communicating, via a time of day tariff controller of a power distribution unit for the medical imaging system, with a smart meter to determine both a non-peak period of a day and a peak period of the day for usage of the electrical power from an electrical grid and related tariff information (e.g., static dynamic tariff information and/or dynamic tariff information) (block 118). The method 116 also includes regulating, via the time of data tariff controller, utilization of the electrical power from both the electrical grid and a battery system of the power distribution unit integrated within the medical imaging system based on a time of the day and the related tariff information (block 120).

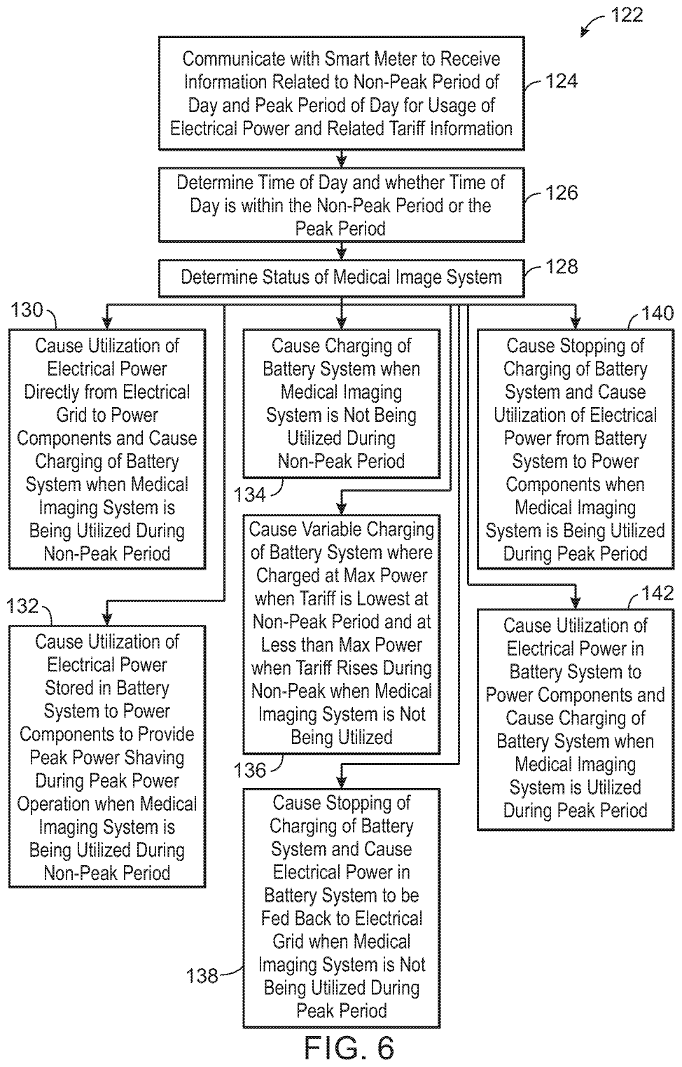

FIG. 6 is flowchart of a method 122 for regulating use of electrical power by a medical imaging system (e.g., for a computed tomography imaging system or other type of medical imaging system). One or more steps of the method 122 may be performed simultaneously and/or in a different order from that depicted in FIG. 5. The method 122 may be performed by one or more components of the power distribution unit 56 in FIG. 4 (e.g., time of day tariff controller 110, power distribution unit controller 108, charge controller/battery charger 90, etc.).

The method 122 includes communicating, via a time of day tariff controller of a power distribution unit for the medical imaging system, with a smart meter to receive information related to a non-peak period of a day and a peak period of the day for usage of the electrical power from an electrical grid and related tariff information (block 124). The method 122 also includes determining a time of day and whether the time of day is within the non-peak period or the peak period (block 126). The method 122 also includes determining a status of the medical imaging system (e.g., idle or running) (block 128).

In certain embodiments, the method 122 includes, when the medical imaging system is being utilized during the non-peak period, causing, via the time of day tariff controller, utilization of the electrical power directly from the electrical grid to power one or more components of the medical imaging system and causing, via the time of day tariff controller, charging of the battery system (block 130). In certain embodiments, the method 122 includes, when the medical imaging system is being utilized during the non-peak period, causing, via the time of day tariff controller, utilization of the electrical power stored in the battery system to power the one or more components of the medical imaging system to provide peak power shaving during peak power operation of the medical imaging system (block 132).

In certain embodiments, the method 122 includes, when the medical imaging system is not being utilized during the non-peak period, causing, via the time of day tariff controller, charging of the battery system (block 134). In certain embodiments, the method 122 includes, when the medical imaging system is not being utilized during the non-peak period, causing, via the time of day tariff controller utilizing dynamic tariff information, variable charging of the battery system where the battery system is charged at maximum power when a tariff is lowest during the non-peak period and the battery system is charged at less than maximum power when the tariff rises during the non-peak period (block 136).

In certain embodiments, the method 122 includes, when the medical imaging system is not being utilized during the peak period, causing, via the time of day tariff controller, stopping of charging of the battery system and causing, via the time of day tariff controller, the electrical power stored in the battery system to be fed back to the electrical grid (block 138). In certain embodiments, the method 122 includes, when the medical imaging system is being utilized during the peak period, causing, via the time of day tariff controller, stopping of charging of the battery system and causing, via the time of day tariff controller, utilization of the electrical power stored in the battery system to power one or more components of the medical imaging system (block 140). In certain embodiments, the method 122 includes, when the medical imaging system is being utilized during the peak period, causing, via the time of day tariff controller, utilization of the electrical power stored in the battery system to power one or more components of the medical imaging system and to cause charging of the battery system (block 142).

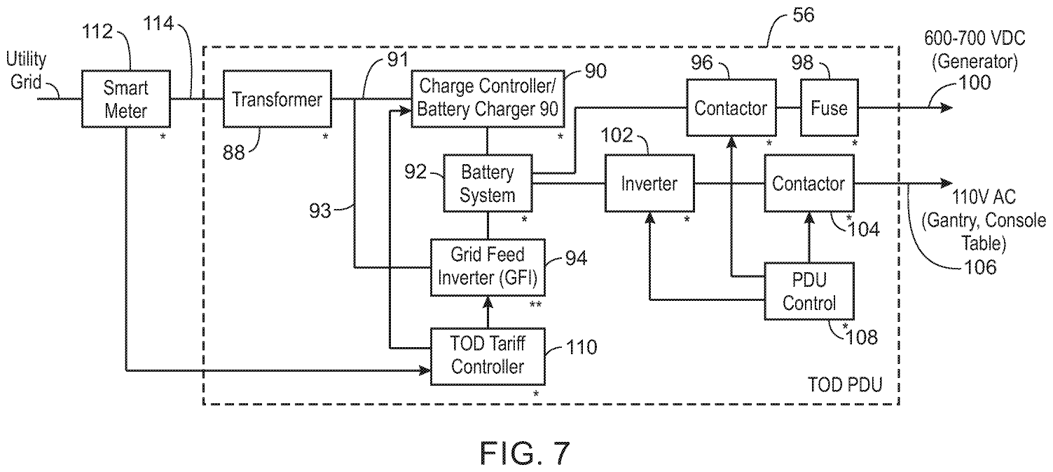

In FIGS. 7-11, a single asterisk indicates an active sub-system of the power distribution unit 56. The time of day tariff controller 110 and the power distribution unit controller 108 are always active. In FIGS. 7-11, two asterisks indicate a turned-off subsystem of the power distribution unit.

FIG. 7 is a block diagram of the power distribution unit 56 for a computed tomography imaging system (e.g., computed tomography imaging system 10 in FIG. 1). FIG. 7 illustrates power distribution operation during non-peak hours and when the computed tomography imaging system is running. The time of day tariff controller 110 communicates with the smart meter to understand the non-peak hours' time block of the day. During that time, the time of day tariff controller 110 utilizes the maximum electricity to charge the battery system 92 and inform the user (e.g., via the operator console) to use the computed tomography system as much as possible by scheduling more patients during that time (i.e., non-peak hours). During these conditions, the battery system 92 is charged with maximum power by charge controller/battery charger 90 and the computed tomography imaging system runs on battery power from the battery system 92. A 600-700 VDC battery bank of the battery system 92 supplies power directly to the high voltage generator with contactor control (e.g., DC contactor 96) and fuse protection (e.g., fuse 98). To generate 110 VAC auxiliary power (to power gantry, console. and table) a suitable size inverter (e.g., inverter 102) is utilized, and a 110V output is controlled by the 110V contactor (e.g., AC contactor 104). The power distribution unit controller 108 controls the AC contactor and inverter operation. In this scenario, computed tomography imaging system generator peak X-ray power is provided by the battery system 92, hence, peak power shaving is taken care by the battery system 92. The grid feed inverter 94 is idle during non-peak hours.

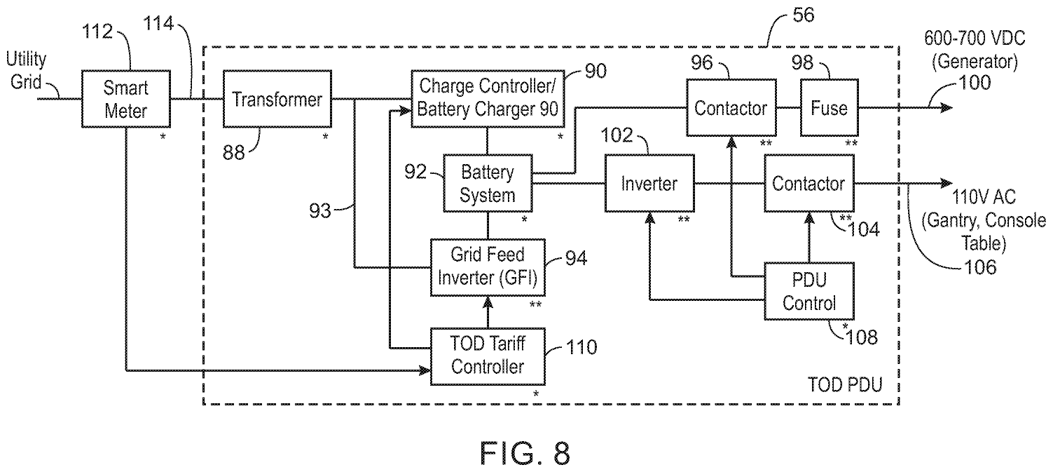

FIG. 8 is a block diagram of the power distribution unit 56 for a computed tomography imaging system (e.g., computed tomography imaging system 10 in FIG. 1). FIG. 8 illustrates power distribution operation during non-peak hours and when the computed tomography imaging system is idle. The scenario in FIG. 8 is similar to the scenario in FIG. 7 with the only change being that the computed tomography imaging system is in idle mode. Therefore, the battery system 92 is charged with maximum power by the charge controller/battery charger 90 to enable fast charging and utilize the low cost benefit of non-peak hours as much as possible as shown in FIG. 8. The charge controller/battery charger 90 can control the charging power according to the dynamic time of day tariff information, based on the information received from the time of day tariff controller 110. The time of day tariff controller 110 receives the dynamic time of day information from the smart meter 112. The battery system 92 can be charged with maximum power when tariff is lowest and charged with a reduced charging current as the tariff goes up. During this time, the power distribution unit output and grid feed inverter 94 are kept in an off condition by time of day tariff controller 110 and the power distribution unit controller 108.

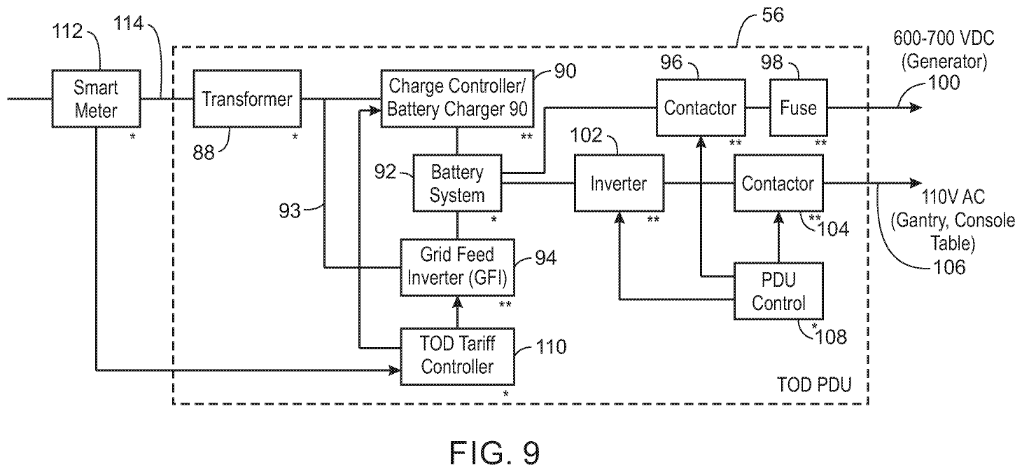

FIG. 9 is a block diagram of the power distribution unit 56 for a computed tomography imaging system (e.g. computed tomography system 10 in FIG. 1). FIG. 9 illustrates power distribution operation during peak hours and when the computed tomography imaging system is idle. During peak hours of the day and when the computed tomography imaging system is in idle condition, the available battery energy can be fed back to the electrical grid as shown in FIG. 9. Peak hours shall be sensed by the smart meter 112 and the time of day tariff controller 110. The time of day tariff controller 110 stops battery charging (e.g., via control signals to the charge controller/battery charger 90) and turns on the grid feed inverter 94 to feed the power to the electrical grid when the cost of electricity is high. If there is no patient being scanned, the power distribution unit 56 controller 108 keeps the computed tomography imaging system in an off condition. However, if the patient is expected to be scanned during peak hours, appropriate battery charge needs to be retained to utilize for the computed tomography imaging system. Thus, the battery system 92 is charged during non-peak hours and the same energy is sold during peak hours with higher cost enabling the computed tomography imaging system to run with near net zero energy cost.

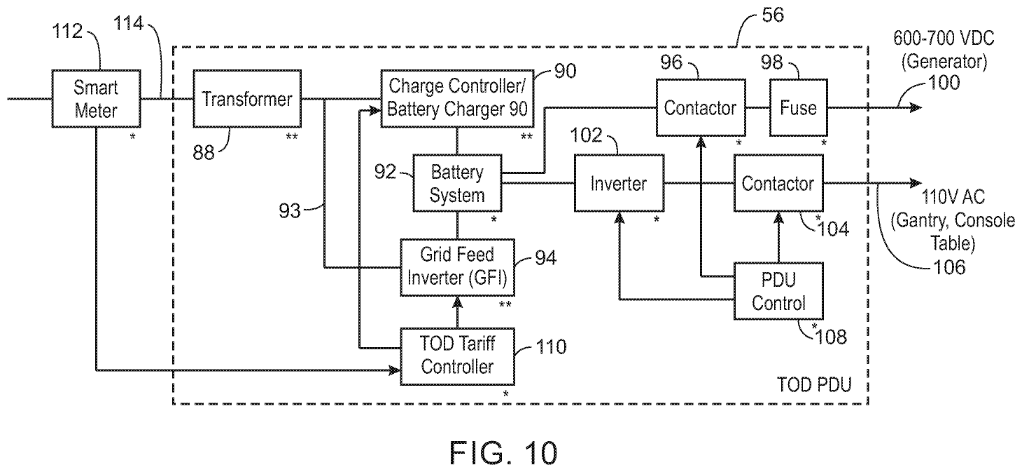

FIG. 10 is a block diagram of a power distribution unit for a computed tomography imaging system (e.g. computed tomography system 10 in FIG. 1). FIG. 10 illustrates power distribution operation during peak hours and when the computed tomography imaging system is running. In this scenario, battery energy is utilized by the computed tomography imaging system during peak hours of the day as shown in FIG. 10. Battery charging is kept off as the cost of energy during this period is high. Also, the grid feed inverter 94 is be kept off as battery energy is getting utilized by the computed tomography imaging system. During this time, the computed tomography imaging system is running only on battery power.

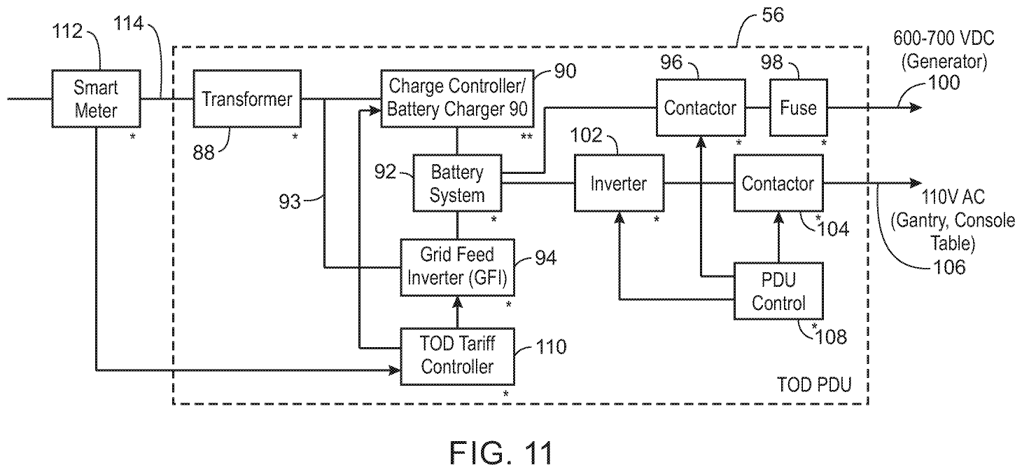

FIG. 11 is a block diagram of a power distribution unit for a computed tomography imaging system (e.g., computed tomography imaging system 10 in FIG. 1). FIG. 11 illustrates power distribution operation during peak hours and when the computed tomography imaging system is running when the battery system 92 has extra charge available. The scenario in FIG. 11 is similar to the scenario in FIG. 10 with the only change being either the power distribution unit 56 has a bigger battery system 92 (e.g., to enable extra charge to be available) or the computed tomography imaging system power requirement is low. In this scenario, the battery system 92 powers the computed tomography imaging system and feeds power to the electrical grid via the grid feed inverter 94 as shown in FIG. 11. The grid feed inverter 94 can be regulated based on the battery energy available and the energy needed by a future examination with the computed tomography imaging system.

Technical effects of the disclosed embodiments include providing a smart medical imaging system that reduces running electricity cost by participating in the time of day power tariff. Technical effects of the disclosed embodiments also include providing for modulating battery charging and discharging based on the dynamic time of day tariff. Technical effects of the disclosed embodiments further include reducing cost as the power distribution unit provides peak power shaving features. Technical effects of the disclosed embodiments even further include enabling one or more components of the medical imaging system to run on battery power (which is of better quality than utility power) which improves the reliability of parts or components. Technical effects of the disclosed embodiments still further include enabling remote health monitoring of the medical imaging system by communicating with a smart meter or the time of day tariff.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

This written description uses examples to disclose the present subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A power distribution unit for a medical imaging system, comprising:
a battery system integrated within the medical imaging system, wherein the battery system is configured to receive electrical power from an electrical grid and to store the electrical power; and
a time of day tariff controller configured to communicate with a smart meter to determine both a non-peak period of a day and a peak period of the day for usage of the electrical power from the electrical grid and related tariff information, wherein the time of day tariff controller is configured to regulate utilization of the electrical power from both the electrical grid and the battery system based on a time of the day and the related tariff information.

2. The power distribution unit of claim 1, wherein the time of day tariff controller is configured when the medical imaging system is being utilized during the non-peak period both to cause utilization of the electrical power directly from the electrical grid to power one or more components of the medical imaging system and to cause charging of the battery system.

3. The power distribution unit of claim 2, wherein the time of day tariff controller is configured when the medical imaging system is being utilized during the non-peak period to cause utilization of the electrical power stored in the battery system to power the one or more components of the medical imaging system to provide peak power shaving during peak power operation of the medical imaging system.

4. The power distribution unit of claim 1, wherein the time of day tariff controller is configured when the medical imaging system is not being utilized during the non-peak period to cause charging of the battery system.

5. The power distribution unit of claim 4, wherein the related tariff information comprises dynamic tariff information, wherein the time of day tariff controller is configured when the medical imaging system is not being utilized during the non-peak period to cause variable charging of the battery system where the battery system is charged at maximum power when a tariff is lowest during the non-peak period and the battery system is charged at less than maximum power when the tariff rises during the non-peak period.

6. The power distribution unit of claim 1, wherein the time of day tariff controller is configured when the medical imaging system is not being utilized during the peak period both to cause stopping of charging of the battery system and to cause the electrical power stored in the battery system to be fed back to the electrical grid.

7. The power distribution unit of claim 1, wherein the time of day tariff controller is configured when the medical imaging system is being utilized during the peak period both to cause stopping of charging of the battery system and to cause utilization of the electrical power stored in the battery system to power one or more components of the medical imaging system.

8. The power distribution unit of claim 1, wherein the time of day tariff controller is configured when the medical imaging system is being utilized during the peak period both to cause utilization of the electrical power stored in the battery system to power one or more components of the medical imaging system and to cause charging of the battery system.

9. The power distribution unit of claim 1, wherein the medical imaging system comprises a computed tomography imaging system.

10. A method for regulating use of electrical power by a medical imaging system, comprising:
communicating, via a time of day tariff controller of a power distribution unit for the medical imaging system, with a smart meter to determine both a non-peak period of a day and a peak period of the day for usage of the electrical power from an electrical grid and related tariff information; and
regulating, via the time of data tariff controller, utilization of the electrical power from both the electrical grid and a battery system of the power distribution unit integrated within the medical imaging system based on a time of the day and the related tariff information.

11. The method of claim 10, further comprising, when the medical imaging system is being utilized during the non-peak period, causing, via the time of day tariff controller, utilization of the electrical power directly from the electrical grid to power one or more components of the medical imaging system and causing, via the time of day tariff controller, charging of the battery system.

12. The method of claim 11, further comprising, when the medical imaging system is being utilized during the non-peak period, causing, via the time of day tariff controller, utilization of the electrical power stored in the battery system to power the one or more components of the medical imaging system to provide peak power shaving during peak power operation of the medical imaging system.

13. The method of claim 10, further comprising, when the medical imaging system is not being utilized during the non-peak period, causing, via the time of day tariff controller, charging of the battery system.

14. The method of claim 13, wherein the related tariff information comprises dynamic tariff information, and further comprising, when the medical imaging system is not being utilized during the non-peak period, causing, via the time of day tariff controller, variable charging of the battery system where the battery system is charged at maximum power when a tariff is lowest during the non-peak period and the battery system is charged at less than maximum power when the tariff rises during the non-peak period.

15. The method of claim 10, further comprising, when the medical imaging system is not being utilized during the peak period, causing, via the time of day tariff controller, stopping of charging of the battery system and causing, via the time of day tariff controller, the electrical power stored in the battery system to be fed back to the electrical grid.

16. The method of claim 10, further comprising, when the medical imaging system is being utilized during the peak period, causing, via the time of day tariff controller, stopping of charging of the battery system and causing, via the time of day tariff controller, utilization of the electrical power stored in the battery system to power one or more components of the medical imaging system.

17. The method of claim 10, further comprising, when the medical imaging system is being utilized during the peak period, causing, via the time of day tariff controller, utilization of the electrical power stored in the battery system to power one or more components of the medical imaging system and to cause charging of the battery system.

18. The method of claim 10, wherein the medical imaging system comprises a computed tomography imaging system.

19. A medical imaging system, comprising:
a power distribution unit, comprising:
a battery system integrated within the medical imaging system, wherein the battery system is configured to receive electrical power from an electrical grid and to store the electrical power; and
a time of day tariff controller configured to communicate with a smart meter to determine both a non-peak period of a day and a peak period of the day for usage of the electrical power from the electrical grid and related tariff information, wherein the time of day tariff controller is configured to regulate utilization of the electrical power from both the electrical grid and the battery system based on a time of the day and the related tariff information.

20. The medical imaging system of claim 19, wherein the medical imaging system comprises a computed tomography imaging system.
